(19) United States
(12) Patent Application Publication
(10) Pub. No.: US 2012/0156657 A1
(43) Pub. Date: Jun. 21, 2012

(54) Educational game set and method of play

(76) Inventor: Thomas Cogan, Stanfield, NC (US)

(21) Appl. No.: 12/928,838

(22) Filed: Dec. 21, 2010

(51) Int. Cl. G09B 19/22

(52) U.S. Cl. 434/129

(57) ABSTRACT

A method of playing an educational card game designed to entertain while teaching children the geography of the United States of America. The invention includes a game board and a deck of specialized game cards. The game board displays a map of the United States with each state specifically color-coded. Each respective card identifies a particular State and bears color-coding corresponding to the State's particular color-coding on the game board. In a preferred embodiment, the object of the game is to dispose of all of the cards in one's hand through the play of cards identifying states which are geographically contiguous with one another. Various versions of the method of play are presented herein.

### FIELD OF THE INVENTION

The present invention relates to an educational card game, and, more particularly, to an educational card game which may be used to teach the geography of the United States of America.

### BACKGROUND OF THE INVENTION

Recent polls and studies have shown that a substantial number of children and young adults in the United States do not have a comprehensive grasp of the geography of their own country. Indeed, many young adults in the world today have difficulty identifying the names or locations of the various States of the Union. Accordingly, there is a clear and long-standing need for teaching materials and methods to help better educate children in this subject.

Interactive learning is rapidly expanding in the area of education. Interactive learning activity, regardless of the specific form of such activity, is thought to more fully engage the student (regardless of age) and facilitate learning in ways that traditional static methods do not. Further, it is frequently considerably easier to encourage a child to play what he or she perceives to be a game rather than ask such a child to engage in what the child knows is an educational activity. Therefore, educational games present an ideal vehicle for educating children through an interactive medium which is not generally perceived as a learning exercise by the child.

Many games known in the art, such as that described in U.S. Pat. Nos. 5,927,719 and 6,457,716, are complicated or overly focused on teaching exceedingly large amounts of information at the expense of maintaining the children's interest. The game disclosed herein is easily learned and maintains an ideal balance between educational purpose and entertainment value.

### OBJECT OF THE INVENTION

It is an object of the invention to provide a game apparatus and a method of use, providing for the play of an educational game whereby players are entertained while acquiring knowledge of the geography of the United States.

### SUMMARY OF THE INVENTION

The present invention describes a design for an educational card game designed to provide entertainment while teaching players about the geography of the United States. The invention includes a game board and a deck of specialized game cards. The game board displays a map of the United States with each state specifically color-coded. Each respective card identifies a particular State and bears color coding corresponding to the State's particular color coding on the game board. The accompanying method discloses the use of the game board and cards in an entertaining and educational game. More than one variation of play is presented, although all variations of play involve acquiring and discarding cards based upon the geographical location of the States identified on those cards.

### DESCRIPTION OF THE DRAWINGS

FIG. 1 illustrates the game board.

FIG. 2 shows a sample game card.

FIG. 3 shows a second sample game card.

FIG. 4 is a flow chart illustrating game play.

FIG. 5 is a flow chart illustrating an alternate manner of game play.

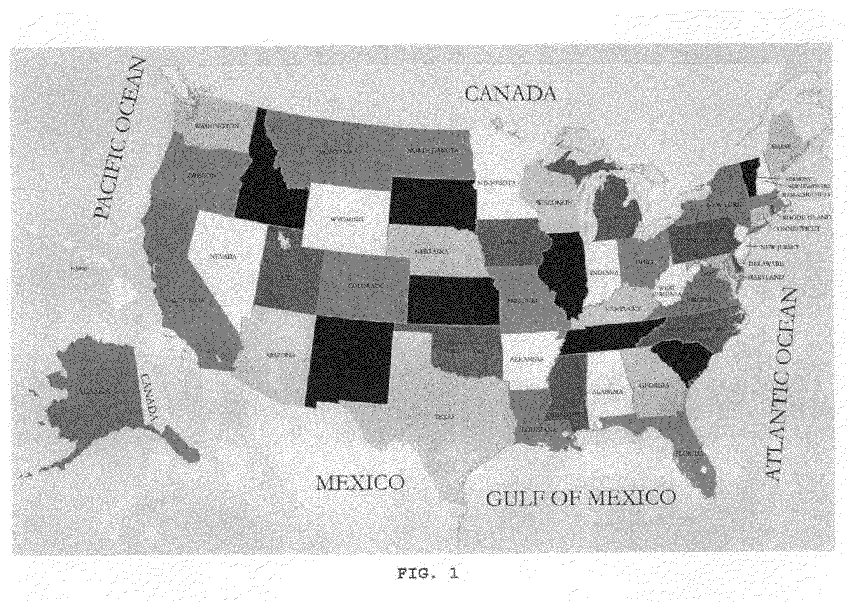

### DETAILED DESCRIPTION

The invention disclosed herein is a game set, including a game board and cards, and a method of play. The purpose of the game is to help the players become familiar with the fifty states of the Union, the contiguous neighbors of each state, and the location of each state in the country. The game can also be used to teach players about various geographical, economic, or other facts concerning each respective state. The game may be played by individuals of any age, but it is particularly suited for children in the third through eighth grades.

The game apparatus consists of a map (100) and a deck of fifty cards. The map (100) is a map of the United States with each state identified by name. The borders of each state are clearly delineated on the map such that an observer can easily deduce which states are contiguous with one another. Each state further bears a particular color coding. Any number or variation of colors may be used.

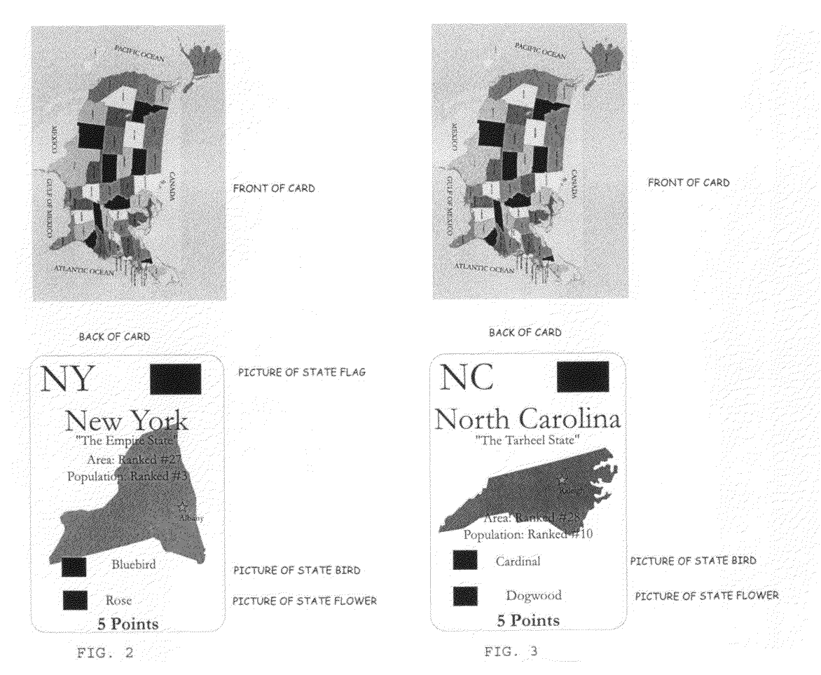

Each of the fifty cards bears the name of a state and other factual information about that state. Exemplary cards (105, 110) are illustrated in FIGS. 2 and 3. One card is provided for each of the fifty states in the United States. Each card has a front (115, 120) and a back (125, 130). In a preferred embodiment, each card has the following information or graphics printed upon it: (a) the name of the state, (b) the two letter postal abbreviation of the state, (c) the state flag, (d) the nickname of the state, (e) the size of the state by rank out of all fifty states, (e) the population of the state by rank out of all fifty states, (f) the state capital, (g) the state bird, and (h) the state flower, as seen in the exemplary cards (105, 110). Each card also bears an outline of the state itself (135, 140) which is color coded so that the color of each state on the cards is identical to the color of the respective state on the map. As seen in FIGS. 2 and 3, it will be noted that the capital of each state (145, 150) may be depicted on each respective card in the geographically correct location in the state. It will be recognized that each card may bear more or less information, or information concerning other subjects, depending on the particular facts which are to be conveyed by the game. Each card also includes a point value (155, 160) of one, five, ten, or fifteen points which are used in certain variations of game play. The back side of the card (165, 170) would include a repetitive design (175) or other such markings as typically found on traditional playing cards. Of course, the back side of the card (165, 170) could bear any words, markings, or other graphics which might be desired.

Each state is color coded with the same color or markings as the state on the map (100) so as to facilitate play for those unfamiliar with the geography of the United States. Younger players can quickly identify a state and its location by simply matching the shape and color of the state on the card to the color and shape of the state on the map (100). The methods of play are all based upon the play of cards bearing contiguous states. Cards bearing the names/images of contiguous states are utilized in a manner generally equivalent to sequentially ranked cards or cards of the same suits as found in a traditional deck of playing cards. Specifically, the methods of play are as follows:

### First Method of Play

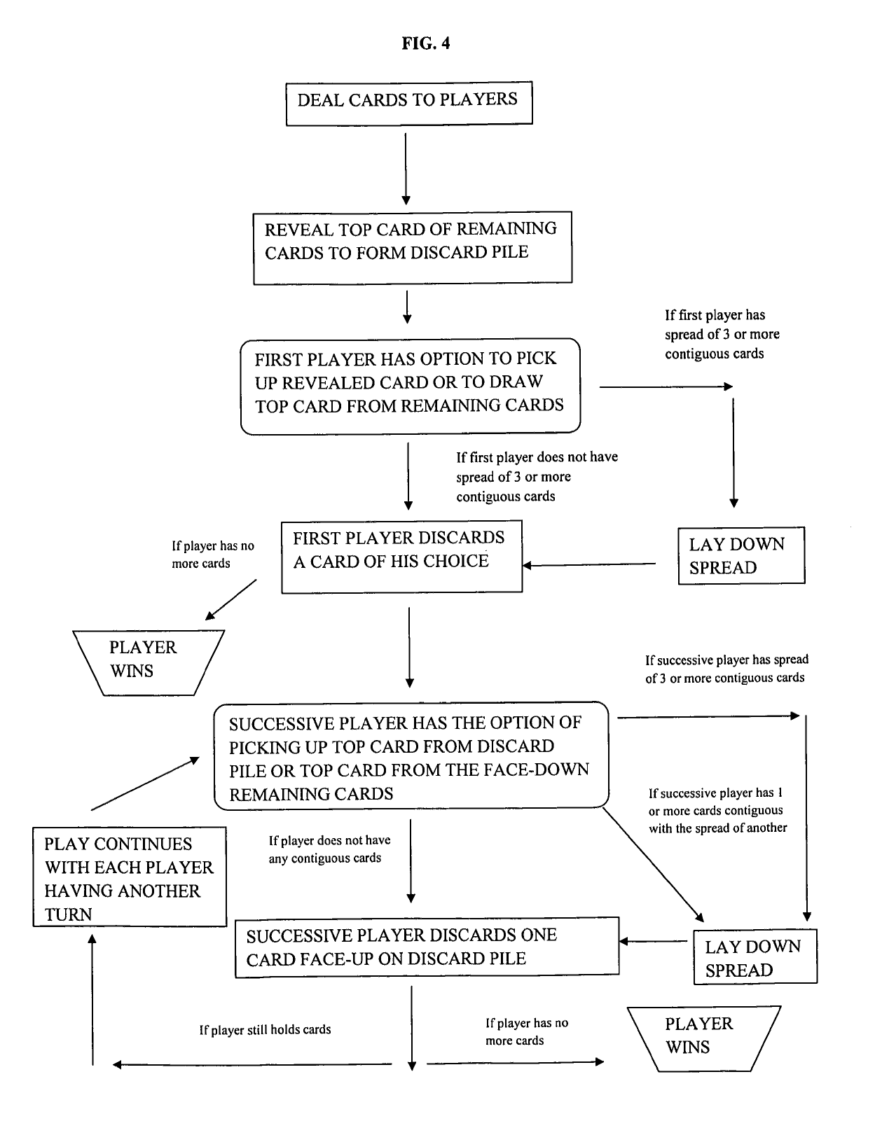

In the most basic version of the game, each player receives seven cards at the inception of play and the object of the game is to dispose of all of the cards in one's hand. This version can be played with two or more players. As players acquire cards in their hand that equal a three or more card spread of states that are contiguous, i.e., border on one another, they lay them down in front of them face up. FIG. 4 illustrates the method of play of the preferred embodiment of the game.

To begin play, the dealer, who may also be a player, deals seven cards, face down, to each player, from left to right. The first card from the deck after dealing is then turned face up. The players may review their own cards, but each player's respective cards are to be shielded from the view of other players. The player to the left of the dealer has the first turn. To begin the turn, the opening player either picks up the top face-up card or draws a card from the deck. The opening player then plays his or her cards, if possible, i.e., laying down three or more contiguous cards, if he or she has any such combination. Once the player has played any cards, he or she discards a card of the player's choice face-up to the discard pile. Play then continues with the next player following the same routine. The second player, and each successive player, picks up a card and then either lays down a spread of three or more contiguous cards, if he or she has any such combination, or he or she may also lay down cards that are contiguous to spreads of cards already played by other players. This continues until one player is able to play the final card with one discard. The first player to discard all of his or her cards wins the game.

This version can also be played using a point system. As noted, each card includes a point value (155,160). If a point system is used to score the game, each player would accumulate the cumulative number of points set forth in the cards that he or she has laid down that comprise one or more spreads of contiguous states minus the cumulative point value of all unmatched cards still remaining in the player's hand. Accordingly, a specific point goal may be set prior to the start of the game and the first player to achieve that goal would win the game.

### Second Method of Play

The second variation is played in a manner similar to the classic card game gin. This version is played by two players. Each player receives ten cards. The first card of the undealt face-down deck is then turned up in the discard pile. The player that did not deal has first option to pick up this card and discard another. If the player passes, the dealer has the option of picking up the turned-up card and discarding another. If the dealer elects not to select this card, the second player draws the first card from the face-down deck and then discards a card. The object of this version is to make at least two sets of three spreads of contiguous states and one spread of four contiguous states. Longer spreads of contiguous states are valid as long as they are accompanied by three-card spreads or one ten-card spread. Players may either lay such spreads down upon achieving each respective spread or wait until they have obtained the cards for all of the necessary spreads. Play continues until one player acquires all of the cards required to accomplish the foregoing goal. The first player to obtain and play the requisite spreads is the winner of the game.

This version can also be played using a point system in a manner similar to the first method of play. In this second version, the player who obtains and plays the requisite spreads would earn a fixed amount of points, e.g., twenty points, as well as all points reflected in unmatched cards (i.e., cards that are not part of a spread of contiguous states) in the opponent's hand. A specific point goal may be set prior to the start of the game and game play, with additional hands, would continue until one player achieves the pre-defined point goal.

### Third Method of Play

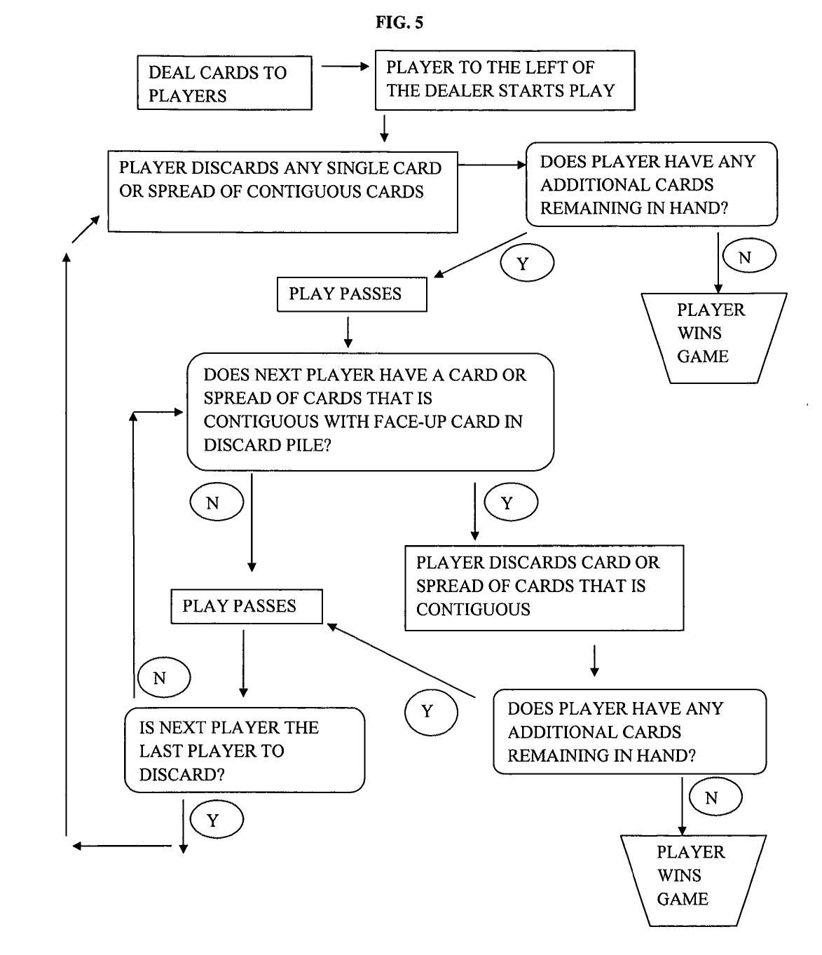

The third method of play, also known as the party version, is played by five or more players. The object of the party version is to be the first player to dispose of all of his or her cards. FIG. 5 illustrates the steps in the third method of play.

In this version, all the cards, i.e., the entire deck, are dealt from left to right to the players. The player to the left of the dealer starts the play by discarding any one card or any combination of cards that are contiguous. These cards form a single discard pile. Obviously, it is most advantageous to lay down a combination of contiguous cards; however, the player may not be in possession of the necessary cards to do so. The next player must then play a card from their hand that is a contiguous state to the top card in the discard pile. If the player does not have a contiguous card, they pass to the next player. If all players pass back to the player that originally played the top card, that player can now play a new card or cards not contiguous to the top card. This routine continues until one player plays their last card. When playing multiple hands of this version, the deal passes to the left so each round is started by a new player.

In all of the foregoing versions of play, the states of Hawaii and Alaska are considered contiguous to one another as with the states of California, Oregon, and Washington. However, Hawaii and Alaska may not be used to connect a spread of non-contiguous states. In other words, neither Alaska nor Hawaii could be used to connect Washington to California. However, connecting Alaska to Hawaii and then to California, Washington, or Oregon would be a proper play.

In addition, other factual information on the cards can be used to vary game play. For instance, spreads may be formed by combining cards having population or size ranks in sequential order. It will also be noted that certain versions of the game are more complex than others. As a result, the game is easily tailored to players of different ages through the selection of a particular version or versions.

While the invention has been described in reference to certain preferred embodiments, it will be readily apparent to one of ordinary skill in the art that certain modifications or variations may be made to the apparatus, system, and method without departing from the scope of invention claimed below and described in the foregoing specification.

What is claimed is:

1. A method of playing an educational card game comprising:
providing a game board having a geographical outline of the United States of America and all states therein;
providing a plurality of specialized game cards;
providing at least two players of said card game wherein each of at least two players shall take successive turns;
dealing seven cards face-down to each of at least two players of said game wherein said dealing results in the creation of a remaining card pile;
creating a draw pile and a discard pile; said discard pile created by turning over the top card of the remaining game cards so as to form a separate discard pile; said draw pile consisting of said remaining game cards;
a first player electing to either acquire a card from the discard pile or to draw a card from the remaining game cards;
said first player then playing his cards;
said first player discarding a card from his hand, said discarded card being placed face-up in said discard pile;
a successive player then following the same routine as said first player; and
repeating such play by each of said at least two players until one of said at least two players is able to play his final card with one discard.

2. The method of playing an educational card game of claim 1 wherein each state on said game board bears a particular color-coding which corresponds with color coding on said plurality of game cards.

3. The method of playing an educational card game of claim 1 wherein each game card bears certain information concerning a particular state of the United States of America.

4. The method of playing an educational card game of claim 1 wherein there is one said game card for each state of the United States of America.

5. The method of playing an educational card game of claim 4 wherein each said game card includes the name of the state.

6. The method of playing an educational card game of claim 4 wherein each said game card includes a drawing or outline of the corresponding state.

7. The method of playing an educational card game of claim 6 with each said outline or drawing having a color corresponding with the color of the state on said game board.

8. The method of playing an educational card game of claim 4 wherein each said game card further includes at least one of the following: postal abbreviation of the state, state flag, nickname of the state, the state capital, the size rank of the state, the population rank of the state, the state bird or the state flower.

9. The method of playing an educational card game of claim 4 wherein said playing his cards comprises said player laying down all combinations of three or more contiguous cards in his possession.

10. The method of playing an educational card game of claim 4 wherein a player may play a spread of three or more cards which identify contiguous states or a player may play cards which identify states which are contiguous with the spreads of cards played by another player.

11. The method of playing an educational card game of claim 4 wherein the object of the game is to be the first player to discard or play all of his cards.

12. The method of playing an educational card game of claim 4 wherein each card includes a point value.

13. The method of playing an educational card game of claim 12 wherein the player acquires the point value of each such card when said card is played whereby it is the object of the game to acquire more points than the other player.

14. A method of playing an educational card game comprising:
providing a game board having a geographical outline of the United States of America and all states therein;
providing a deck of specialized game cards; said deck having one card corresponding to each state in the United States;
dealing ten cards face-down by a first player to each of two players of said game;
turning over the top card of the remaining game cards so as to form a separate discard pile;
offering a second player the option to collect said top card from said discard pile;
if said second player does not collect said top card, offering said first player the option to pick up said top card and then place a card of said first player's choice in the discard pile;
if said first player fails to collect said top card, said second player drawing a card from the remaining game cards and then placing a card of said second player's choice in the discard pile; and
continuing play until one of said players possesses at least two sets of spreads of three cards identifying contiguous states and one spread of four cards identifying contiguous states whereby said player is the winner.

15. The method of playing an educational card game of claim 14 wherein each said card includes the name of the state.

16. The method of playing an educational card game of claim 14 wherein each said card includes a drawing or outline of the corresponding state.

17. The method of playing an educational card game of claim 14 with each said outline or drawing having a color corresponding with the color of the state on said game board.

18. The method of playing an educational card game of claim 14 wherein each said card further includes at least one of the following: postal abbreviation of the state, state flag, nickname of the state, the state capital, the size rank of the state, the population rank of the state, the state bird, the state flower or a point value.

19. The method of playing an educational card game of claim 14 further comprising playing for points, said playing for points comprising: the winner accumulating a pre-determined number of points as well as the point value of unmatched cards in the hand of the other player.

20. A method of playing an educational card game comprising:
providing a game board having a geographical outline of the United States of America and all states therein;
providing a deck of specialized game cards; said deck having one card corresponding to each state in the United States;
providing five players who will take successive turns of play; one of said players being a dealer; and further, the player to the left of said dealer being a first player;
said dealer dealing all of said game cards to said players;
said first player taking his turn of play, said turn of play comprising:
discarding any single card or any combination of contiguous cards; said cards being placed in a single pile with the top-card face up so as to form a discard pile;
passing turn of play to the successive player of the group;
the successive player of the group taking his turn of play, said turn of play comprising:
discarding a card that is contiguous with said top-card of said discard pile and, further, discarding any additional cards that are contiguous with such discarded card; if the player is unable to discard a card that is contiguous with said top-card, then said turn of play passing to the successive player in the group;
passing play to the successive players of the group until either one of said players discards all of his cards or said turn of play returns to the last player to discard a card or cards;
said last player to discard a card taking his turn of play, said turn of play comprising:
discarding any single card or any combination of contiguous cards in said discard pile;
continuing play in such repetitive fashion until a player wins said game by discarding all of his cards.
